(19) United States
(12) Patent Application Publication
(10) Pub. No.: US 2018/0338565 A1
(43) Pub. Date: Nov. 29, 2018

(54) SHOE WITH PLATES

(71) Applicant: Jahaziel Aguirre, Andrews, TX (US)

(72) Inventor: Jahaziel Aguirre, Andrews, TX (US)

(21) Appl. No.: 15/990,573

(22) Filed: May 25, 2018

Related U.S. Application Data
(60) Provisional application No. 62/510,939, filed on May 25, 2017.

(51) Int. Cl. A43B 7/32; A43B 3/04; A43B 23/02; A43B 1/08; B32B 3/16; B32B 7/12

(52) U.S. Cl. CPC A43B 7/32; A43B 3/04; A43B 23/027; A43B 23/0275; A43B 1/08; B32B 2437/02; A43B 23/023; A43B 23/0235; B32B 3/16; B32B 7/12; A43B 23/0225

(57) ABSTRACT

A boot including an outsole, an upper attached to the outsole, where the upper has a vamp portion including a first layer, a second layer, and a layer of plates disposed between the first layer and the second layer. The layer of plates are arranged in one or more rows across the vamp portion. The shape of the layer of plates conforms to a shape of the upper. And in the layer of plates, a first individual row of the one or more rows stretches with respect to a second individual row of the one or more rows. The location of the layer of plates may correspond to a region of the foot within the boot including the metatarsus. The location of another layer of plates may correspond to a region of the leg within the boot including a portion of the tibia.

### CROSS-REFERENCE TO RELATED APPLICATIONS

The application claims the benefit of U.S. Provisional Patent Application No. 62/510,939, filed May 25, 2017, titled “Steel Toe Top Boot,” which provisional application is incorporated by reference herein as if reproduced in full below.

### BACKGROUND

Shoes may serve one or more functions including adding style to an outfit or providing protection and comfort to a foot. Shoes may be made from a variety of materials including leather, wood, rubber, plastics, and other petrochemical-derived materials. Shoes may protect the human foot from environmental hazards such as sharp rocks and temperature extremes. Some shoes may be worn as safety equipment, such as steel-soled or steel-toed boots.

### BRIEF DESCRIPTION OF THE DRAWINGS

For a detailed description of various embodiments, reference will now be made to the accompanying drawings in which:

FIG. 1 shows a cross section view of a boot in accordance with example embodiments;

FIG. 2a shows a perspective view of the boot in accordance with example embodiments;

FIG. 2b shows a perspective view of the boot in accordance with example embodiments;

FIG. 2c shows a perspective view of a plate in accordance with example embodiments;

FIG. 3a shows a side elevation view of a layer of plates and a supporting layer in accordance with example embodiments;

FIG. 3b shows a top plan view of a layer of plates in accordance with example embodiments;

FIG. 3c shows a top plan view of a layer of plates in accordance with example embodiments;

FIG. 3d shows a top plan view of a layer of plates in accordance with example embodiments;

FIG. 4 shows a method for constructing a layer of plates and embedding the layer within a shoe in accordance with example embodiments;

### DETAILED DESCRIPTION

The following discussion is directed to various embodiments. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Certain terms are used throughout the following description and claims to refer to particular system components. As one skilled in the art will appreciate, different companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .”

Shoes and more particularly boots may be used as safety equipment. For example, individuals working with heavy equipment, tools, and machinery may wear steel-toed boots. Some steel-toed boots may include a durable boot or shoe that has a protective reinforcement in the toe which protects the foot from falling objects or compression as well as a mid-sole plate to protect against punctures from below.

A steel-toed boot with a mid-sole plate is effective at protecting the toes and the bottom of the foot, however, the steel-toed boot does not protect other regions of the foot from a heavy or sharp object such as a hammer or knife, falling on the foot. For example, a steel-toed boot does not protect against a heavy or sharp object falling on the top part of the foot (e.g., including the metatarsus, cuneiform, and navicular bones). Nor does a steel-toed boot protect against a heavy or sharp object that might collide with the regions of the lower leg including the fibula and tibia.

Accordingly, to protect the top region of the foot and regions of the lower leg, various embodiments are directed to a shoe or boot with embedded protective reinforcement, in the form of a layer of plates. The layer of plates are embedded within the boot in regions that coincide with covering the top part of the foot extending from the region of the foot including metatarsus and the region of the lower leg, including the fibula and tibia. The protective reinforcement provides a layer of protection that can withstand a heavy impact or impede the path of a sharp object. The protective reinforcement, is designed to be flexible such that the protective reinforcement does not interfere with a boots ability to bend or fold. The protective reinforcement is embedded within the upper of the boot and thus is not visible to an individual.

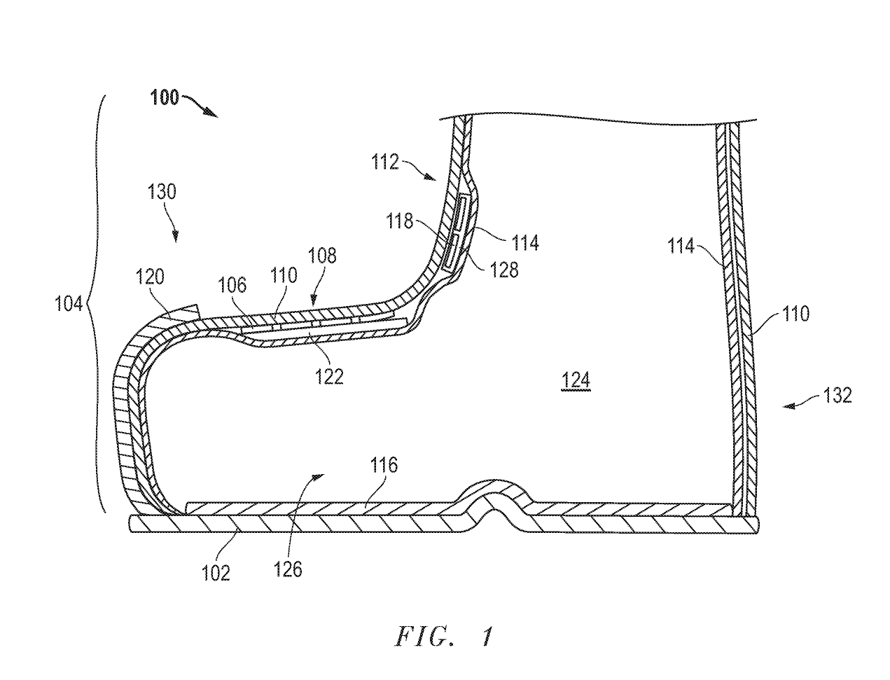

The discussion begins in reference to a boot in accordance with various embodiments, then proceeds to example layers of plates that may be embedded within the boot to provide protection to the top part of the foot and to regions of the lower leg, and then to an example method of fabricating a boot in accordance with some embodiments. The discussions of FIGS. 1-4 include features or elements that may be used in conjunction with each other. Although the examples discussed reference a boot, a boot is considered to be a type of shoe, and accordingly, the embodiments discussed herein may be applied to any type of shoe that may accommodate the layer of platers as discussed herein.

FIG. 1 shows a cross section view of a boot 100 in accordance with example embodiments. In particular, the boot 100 comprises an outsole 102, the upper 104, and one or more layers of plates 106 and 118 embedded throughout the upper 104 of boot 100. Outsole 102 forms the bottom part of boot 100. When boot 100 is worn, at least one surface of outsole 102 comes in direct contact with the ground and is exposed to wear. Further, outsole 102 may be made from a variety of different natural or synthetic materials, including natural rubber, resin rubber, leather, polyurethane, Polyvinyl chloride (PVC) compounds and other materials. The material used to make outsole 102 depends on the style and purpose of boot 100. In some cases, the thickness of the outsole 102 may vary from one centimeter to an inch depending on the purpose of the boot 100.

Outsole 102 may include a single piece or may be made of several pieces adjoined together. Different portions of outsole 102 may have different materials, for example the heel of the outsole may have a rubber plate or outsole 102 may be cleated. In some embodiments, outsole 102 may be attached to upper 104 by a welt or other adjoining technique. Insole 116 may be disposed on top of outsole 102.

Upper 104 refers to portions of boot 100 that hold boot 100 onto a foot. Upper 104 is attached to outsole 102, and the combination of upper 104 and outsole 102 define a volume 124 within which a foot may be placed. Upper 104 includes the part or parts of boot 110 that cover the toes, the top of the foot, the sides of the foot, the back of the heel, and the lower part of the leg.

Different regions of the upper 104 may include the vamp 108 and the shaft 112. Vamp 108, refers to the forepart of the upper 104 and covers the top of the foot at the front and center. Shaft 112 refers to the portion of the upper 104 that rises from above vamp 108. Shaft 112 covers regions of the lower leg, including the fibula and tibia.

Upper 104 may be made of one or more layers adjoined together. For example, upper 104 may have an exterior layer, (a first layer 110) that wraps around the boot and is visible on the outside of boot 100. The first layer 110 may be made from a variety of different natural or synthetic materials, including leather, satin, suede, canvas, breathable mesh fabric, and the like. The first layer 110 may also have a thickness between one centimeter and five centimeters depending on material selected. Adjacent to the first layer 110 and disposed along the interior surface of upper 104 may be a second layer 114.

Second layer 114 may have a shape relatively the same as the first layer 110. The second layer 114 may also be made from a variety of different natural or synthetic materials, including leather, satin, suede, canvas, breathable mesh fabric, and the like. The second layer 114 may also have a thickness between one centimeter and five centimeters depending on material selected. It should be understood that the upper 104 may have additional layers located between the first layer 110 and the second layer 114. For instance, the upper 104 may have a stiffening layer, a cushioning layer, and the like disposed between a portion of the first layer 110 and the second layer 114.

In one example, first layer 110 is comprised of leather. Second layer 114 may also be comprised of leather, or be made of material that is thinner and softer than first layer 110, where second layer 114 provides comfort to the wearer. In one example, second layer 114 may be an inside lining within the interior of boot 100 and exposed to the volume 124 for receiving the foot.

The bottom peripheral edges of both the first layer 110 and second layer 114 may be sewn to insole 116. Insole 116 may contact the foot and is positioned atop the outsole 102. In some embodiments, insole 116 may be a sock lining. Thus, insole 116 may have a thickness between one millimeter and five centimeters.

Boot 100 may also comprise a protective reinforcement cap 120 disposed along the outside front portion 130 of upper 104, where the front portion 130 of upper 104 may be defined as where the toes are positioned. A back portion 132 of upper 104 is defined as where the heel is positioned. Protective reinforcement cap 120 may serve as a toe cap and may be made of steel, a composite material, plastic such as thermoplastic polyurethane (TPU), aluminum, or other materials that may provide protection to the toes during use. In some embodiments, protective reinforcement cap 120 may be removable.

The upper 104 may comprise one or more protective reinforcements, or layers of plates. For example, embedded within a portion of the upper 104, and more particularly in the vamp 108, is a layer of plates 106. The layer of plates 106 may begin near the front portion 130 of upper 104. The layer of plates 106 may be disposed near the front portion 130 of upper 104 without overlapping the protective reinforcement cap 120. That is, the layer of plates 106 may begin at or around where the protective reinforcement cap 120 ends and the layer of plates 106 may extend away from the front portion 130 toward the shaft 112 of boot 100 or toward the back portion 132 of the boot 100.

The layer of plates 106 are embedded the upper 104, and more specifically, the layer of plates 106 is sandwiched between first layer 110 and second layer 114. Accordingly, the layer of plates 106 is not visible from the outside of boot 100 nor when looking inside boot 100. That is, the layer of plates is not visible at the exterior of the boot, nor is it visible from the interior of the boot (viewed from within volume 124).

The layer of plates 106 may span the vamp 108 both across the width of vamp 108 (i.e., from proximal side 126 of boot 100 to a distal side of boot 100) and for a given length (i.e., from a front portion of upper 104 toward back portion 132). That is, when boot 100 is worn, the layer of plates 106 may protect the region of the foot including the metatarsus from falling machinery, knives, equipment, or other sharp and heavy objects.

In another example, the layer of plates 106 may span both the vamp 108 and the shaft 112. Accordingly the layer of plates 106 may comprise continuous row of plates, starting near the front portion of upper 104 and spanning up into the shaft 112 of boot 100.

Individual plates in the layer of plates 106 may be made from metals (e.g., steel, chromium, titanium, aluminum, metal, graphite, zinc, bronze, copper, nickel, lead, tin, cadmium, and the like), composite materials, fiber reinforced polymers, KEVLAR®, a strong synthetic fiber (e.g., Twaron), and the like. The individual plates may be between 0.02 inches and one inch thick. In yet another example, the individual plates may be between 0.01 inches and 0.2 inches thick.

In the example illustrated in FIG. 1, the layer of plates 106 comprise multiple rows of plates. Thus, a layer of plates as used herein may comprise one or more rows of plates. Further, an individual row of plates may comprise one or more plates arranged in a row and held together in a row arrangement by one or more elastic members. The layer of plates 106 are disposed within the layers 110 and 114 comprising upper 104, in a manner that allows the layer of plates 106 to expand and contract in a flexible manner to accommodate a bending or flexing foot. In some cases, the number of rows of plates running from the front portion 130 toward the back portion 132 may vary between one and 20, depending on the size of the boot 100, and a size of the plates.

Further, each row of plates may include between four and 16 plates, again depending on the size of the boot and a size of the plates. The width of each plate may vary between 0.02 inches and two inches, and the length of each plate may vary between 0.02 inches and two inches. In yet another example, the width and length of each plate may vary between 0.02 inches and 0.5 inches.

The layer of plates 106 may be further disposed upon a supporting structure 122. The supporting structure 122 may provide both support to the layer of plates 106 as well as serve as an additional layer to absorb the impact of a heavy object falling on the layer of plates 106. The supporting structure 122 may be made of foam, fabric, composite material, or any material suited for absorbing, softening, or withstanding high impact.

The supporting structure 122 may have a shape that conforms to the shape of the vamp 108 of the upper 104. The supporting structure 122 may be between 0.1 inch and one inch thick. Additionally, the supporting structure 122 may be between five to seven inches wide and between seven to 8.5 inches long.

Additional layers of plates may be found in other portions of the upper 104. That is, the layers of plates may be placed in any section of the upper 104 that may accommodate the presence of the layer of plates. For example, an additional layer of plates 118 may be placed within the shaft 112. The additional layer of plates 118 may be affixed to and disposed upon supporting structure 128. In turn, the supporting structure 128 may be affixed to the second layer 114. Similar to the layer of plates 106 embedded within the vamp 108, the additional layer of plates 118 is flexible and may stretch, contract, and flex as portions of the shaft 112 bend and flex. In some cases, the number of rows of plates running along the shaft 112 of the upper 104 may vary between two and ten, depending on the size of the shaft 112 and the size of the plates.

Further, each row of plates may include between four and 25 plates, depending on the circumference of the shaft 112 and whether protection is desired around the entirety of the lower leg or around a portion of the lower leg. The width of each plate may vary between 0.02 inches and two inches, and the length of each plate may vary between 0.02 inches and two inches. In yet another example, the width and length of each plate may vary between 0.02 inches and 0.5 inches. The individual plates may also be between 0.02 inches and one inch thick. In yet another example, the individual plates may be between 0.01 inches and 0.2 inches thick.

Thus, boot 100 comprises one or more layer of plates that may be embedded throughout and in various parts of the upper. The layer of plates are not visible from either the outside of the boot or from the inside (where the foot is placed) and further the layer of plates conform to the shape of the upper. The layer of plates are constructed such that the layer may bend and flex with the upper of the boot while also providing protection when a heavy or sharp object falls on a person's foot or leg. The layer of plates may include a support structure that may also provide additional cushioning to absorb impact.

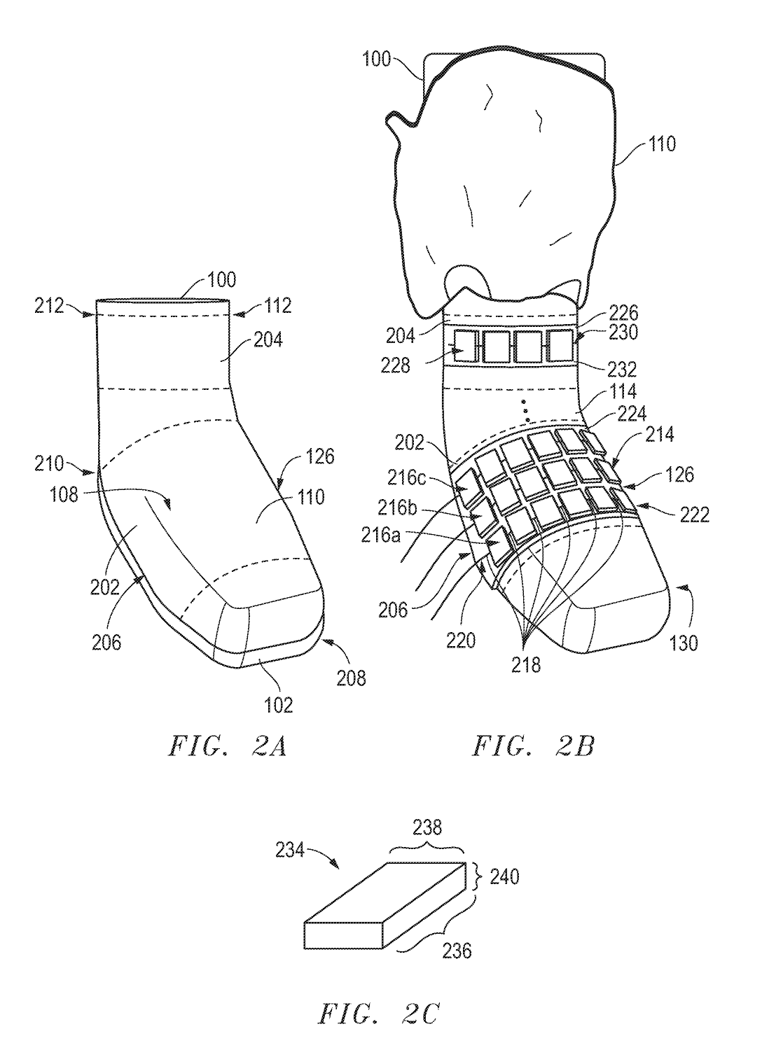

FIGS. 2a and 2b show additional aspects of the layers of plates embedded within boot 100 (such a layers of plates 106 and 118). Some of the features or elements of FIG. 1 may be used in conjunction with FIG. 2. For example, the boot 100 illustrated in FIGS. 2a and 2b is the same as boot 100 described in FIG. 1. In particular, FIG. 2a shows a perspective view of boot 100 in accordance with example embodiments. FIG. 2a illustrates a finished boot 100 where the upper of boot 100 is covered by the exterior first layer 110 (as described in FIG. 1).

In FIG. 2a, a first section 202 and a second section 204 represent areas where one or more layer of plates may be embedded within the upper of boot 100. A first section 202 indicated by dotted lines extends from a proximal side 126 (as described in FIG. 1) to a distal side 206 of the boot 100. Additionally, the first section 202 extends from a front portion 208 of boot 100 toward a back portion 210. When boot 100 is worn, first section 202 would cover approximately the region of the foot including the metatarsus. A layers of plates may be present in all or a portion of first section 202.

The second section 204 indicated by dotted lines wraps around the shaft 112. The second section 204 may extend from the top 212 of the shaft toward the outsole 102 (as described in FIG. 1). A layer of plates may be present in all or a portion of second section 204. That is, one or more layers of plates may wrap around the entire circumference of shaft 112 or one or more layers of plates may wrap around shaft 112 within a portion of section 204. When boot 100 is worn, second section 204 would cover approximately the region of the lower leg including the fibula and tibia.

In the illustrated example, two sections 202 and 204 of plates are shown, however, it should be understood that the boot 100 may have between one and six different sections of layers of plates embedded between the first layer 110 and the second layer 114 (i.e., the upper of the boot 100). For example, the boot 100 may have one continuous section of embedded rows of plates spanning from the vamp 108 into the shaft 112.

FIG. 2b shows a perspective view of boot 100 with the exterior first layer 110 removed. Accordingly, one or more layers of plates are exposed and portions of the second layer 114 (FIG. 1) are also exposed. Within section 202, the layer of plates 214 may include one or more rows of plates. In FIG. 2b, rows of plates 216a, 216b, and 216c are shown. The layer of plates 214 may include more or fewer rows of plates. The row of plates 216a, is placed closer to the front portion 130 of the upper of boot 100, while the row of plates 216c is placed closer to where the vamp and the shaft meet.

The row of plates 216a is embedded within the vamp of boot 100 such that it stretches across the vamp from one side of the boot (distal side 206) to the other side of the boot (proximal side 126). The row of plates 216a, includes individual plates arranged in a row and held together in row formation by one or more flexible members 218 that may be formed from elastic, various polymers, and the like.

The individual plates in row of plates 216a, 216b, and 216c, may be made of any material able to withstand the impact of a heavy blow from machinery falling on the plate, or withstand the impact of a sharp object such as a knife falling on the plate. For example, as mentioned in FIG. 1, the individual plates may be made out of metals, composite materials, fiber reinforced polymers, KEVLAR®, Twaron (a strong synthetic fiber), and the like.

As also mentioned in FIG. 1, the individual plates may be between 0.02 inches and one inch thick. In yet another example, the individual plates may be between 0.01 inches and 0.2 inches thick. The width of each plate may vary between 0.02 inches and two inches, and the length of each plate may vary between 0.02 inches and two inches. In yet another example, the width and length of each plate may vary between 0.02 inches and 0.5 inches.

The individual plates within row of plates 216a, 216b, and 216c, may be rigid or made of material demonstrating high-strength that may also be semi-flexible. For example, the individual plates may have a tensile strength of around 290 to 370 megapascal (MPa) and may be up to 3,620 MPa. Individual plates may have a hardness grade on the Mohs scale of hardness of around four and up to around nine.

The row of plates 216a, as a whole, however, may stretch or contract or move around flexibly due to one or more flexible members holding the individual plates together in a row arrangement. In the example shown in FIG. 2b, the row of plates 216a is held together by one or more flexible members 218 comprising an elastic string.

For example, each individual plate of the row of plates 216a is affixed to the elastic string. Furthermore, the ends 220 and 222 of the elastic string are affixed to the supporting structure 224. The elastic string may be affixed to the supporting structure 224 using any known method of joining two materials together.

For example, the ends of the elastic string may be affixed to the supporting structure 224 by an adhesive such as glue, a hot melt adhesive, wood glue, or fasteners such as staples, tape, and the like. In one example, the elastic string may wrap the supporting structure 224 such that the ends 220 and 222 are connected at a position below the supporting structure 224.

Recall from FIG. 1, that the supporting structure (e.g., supporting structure 122 and 128, and here supporting structure 224) on which the layer of plates is affixed may be comprised of foam, fabric, composite material, or any material suited for absorbing, softening, or withstanding high impact. The supporting structure 224 may have the ability to conform to the shape of the upper. As the row of plates 216a, is held together by an elastic string, and the elastic string is affixed to the supporting structure 224 only by both ends of the elastic string, the row of plates 216a may stretch or contract or otherwise move freely, given the elasticity of the string. That is, the movement of the individual plates in the row of plates 216a is limited by how far the elastic string may stretch.

The description of the row of plates 216a would apply to the additional rows of plates shown in section 202. That is, the individual rows 216b and 216c may be constructed in a fashion similar to that of row 216a. Accordingly, the rows 216a, 216b, and 216c (combined together making the layer of plates 214) may stretch, contract, or move within individual rows and with respect to one another. Accordingly, the layer of plates 214 may have the ability to withstand high impact while also having the ability to flex and bend as a boot wearer bends his foot. While three rows 216a, 216b, and 216c are illustrated, the number of rows may vary between one and 20 depending on the size of the individual plates and the size of the boot 100. In other cases, the number of rows of plates may vary between two and five.

As mentioned in FIG. 1, one or more layer of plates, similar to layer of plates 214, may be embedded anywhere in the upper of boot 100. For example, a layer of plates 226 may be embedded within the shaft of boot 100, or within section 204. In another example, the layer of plates 226 may run entire length of the shaft of the boot 100 or run the whole length of the upper of the boot 100. The layer of plates 226 comprises a row of plates 228, where individual plates in the row are held together by a flexible member 230, such as an elastic member. Similar to the row of plates 216a, the row of plates 228 is affixed to a supporting structure 232. Different parts of the flexible member 230 may be affixed to the supporting structure 232. In one example, the two ends of the flexible member 230 are affixed to the supporting structure 232. In another example, the two ends and a middle portion of the flexible member 230 may be affixed to the supporting structure 232.

FIG. 2c shows a perspective view of an individual plate that may be used in any of the layer of plates discussed herein. Thus, the discussion of the individual plate 234 is applicable to any plate that may be used in a layer of plates as discussed herein, and more specifically as discussed in FIGS. 1, 2a, 2b, 2c, 3a-3d, and 4.

The individual plate 234 may have any symmetrical or asymmetrical shape including rectangular, square, circular, oblong, triangular, hexagonal, and the like. The particular example plate 234 shown in FIG. 2c has a rectangular shape. Similar to the plates discussed in FIGS. 1, 2a and 2b, the plate 234 may have a length 236 ranging between approximately 0.02 inches and two inches, a width 238 ranging between approximately 0.02 inches and two inches. Plate 234 may have a thickness 240 ranging between approximately 0.02 inches and one inch. In another example, the width 238 and length 236 of the plate 234 may vary between 0.02 inches and 0.5 inches and the thickness 240 may range between 0.01 inches and 0.2 inches thick. Of note, these ranges are disclosed to provide an example of dimensions of plates that may be used in any of the layer of plates as described herein. The plates that may be used in any layer of plates as discussed herein, are not limited to these ranges.

Thus, FIGS. 2a, 2b, and 2c provide additional details of the layer of plates that may be embedded within the upper of a boot or shoe, such as boot 100 (FIG. 1). One or more layer of plates are constructed such that the layer may bend and flex with the upper of a boot or shoe while also providing protection when a heavy or sharp object falls on a person's foot. One or more layer of plates may be embedded in portions of the upper that coincide with regions of the foot including the metatarsus as well as regions of the lower leg including the fibula and tibia (when a boot is worn).

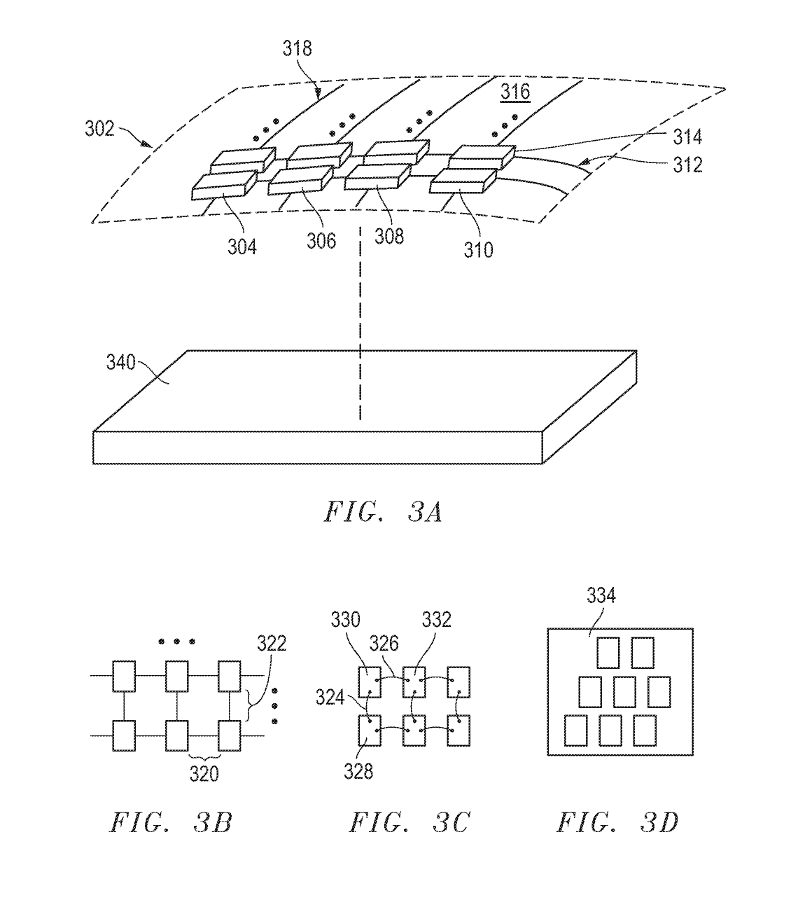

FIG. 3a shows a side elevation view of a layer of plates 302 and a supporting layer 304 in accordance with example embodiments. Layer of plates 302 is comprised of one or more rows of plates, (e.g., rows 304, 306, 308, and 310). Each row of plates may be comprised of one or more individual plates, where the individual plates are held together in a row arrangement by one or more flexible members. The layer of plates 302 may be embedded within boot 100 as described and referenced in FIGS. 1, 2a, 2b, and 2c.

In row 304 of the layer of plates 302, the two plates may be glued or otherwise affixed to a flexible member, such as elastic string 318. When elastic string 318 is stretched, the two plates may move away from each other. When elastic string 318 is brought back to a neutral state, the two plates may move closer together. Thus the elastic string 318 may provide some structure as to how the two plates are arranged (in a row) but allow for the plates to move in relation to each other. That is, the elastic string 318 may assist in maintaining the arrangement of the plates while still allowing the plates to move.

In another example, a particular row of plates may be bound to an adjacent row of plates by additional elastic members. For example, row of plates 304 may be bound to row of plates 306, and so on by flexible members such as elastic member 312 to form column 314. Thus, the layer of plates may be bound both as rows and columns, by flexible members.

Of note, although flexible members have been described as an elastic member such as an elastic string, a flexible member may take any shape or form that effectively binds the individual plates in a manner that allows the plates to move away or move closer in relation to each other. A flexible member may also include flexible polymers. As another example, instead of an elastic string, a flexible member may also include an elastic sheet 316. The individual plates may be affixed to the elastic sheet 316, and when the elastic sheet 316 is stretched one way, the individual plates may move and stretch with the elastic sheet 316.

Continuing the example including individual rows 304, 306, 308, and 310 held together by a flexible member such as an elastic string, the individual elastic strings may be affixed to supporting structure 340. In one example, both ends of elastic string 318 may be glued to the supporting structure 340. As both ends of the elastic string 318 are glued, the remaining portions of the elastic string, and plates on the elastic string may stretch and bend.

FIGS. 3b, 3c, and 3d show a top plan view of a layer of plates in accordance with example embodiments. Any layer of plates discussed herein (FIGS. 1-4) may comprise individual plates arranged in row or columns in a grid like manner or in any other manner that maintains the effectiveness of the individual plates to withstand high impact while still maintaining flexibility of the layer of plates. For example, the individual plates may be held together by one or more types of flexible members, where the individual plates may be arranged in rows and columns, staggered rows, staggered columns, in a chainmail pattern, in a fish scale pattern, and the like. Accordingly, in some embodiments where a chainmail pattern or a fish scale pattern are implemented, one or more individual plates may partially overlap other individual plates.

In FIG. 3b, individual plates may be held together by flexible members comprising elastic strings. In FIG. 3b, individual plates are held together in both rows and columns by the elastic string to form a grid. The individual plates may be glued to the elastic string. As the grid of plates is bound by flexible members, the spacing between the individual plates in the grid may change, thus creating a flexible layer of plates.

Individual plates may be spaced along the elastic string by a predetermined distance apart from each other. For example, in a row, the distance 320 between two adjacent plates may range approximately between 0.002 inches and one inch. Additionally, the distance 322 between two adjacent plates in a column may also range approximately between 0.002 inches and one inch. In other examples, plates may partially overlap each other.

In FIG. 3c, individual plates are held together in both rows and columns by flexible members, comprising shorter elastic strings or rubber bands. For example, plate 330 and 332 may be arranged in a row and held together by flexible member 326. In this example, respective ends of flexible member 326 may be glued to plates 330 and 332. In another embodiment, holes may be drilled through plates 330 and 332. Flexible member 326 may subsequently be thread through respective holes and the ends of flexible member 326 may be tied or glued to plates 330 and 332.

Additionally, plate 330 and 328 may be arranged in a column and held together by flexible member 324. In this example, respective ends of flexible member 324 may be glued to plates 330 and 328. In another embodiment, holes may be drilled through plates 330 and 328. Flexible member 328 may subsequently be thread through respective holes and the ends of flexible member 324 may be tied or glued to plates 330 and 328.

In FIG. 3d, individual plates may be held together in any given arrangement by a flexible member comprising elastic sheet 334. That is, the individual plates may be arranged in a grid like pattern in rows and columns, or arranged in other patterns including staggered rows or staggered columns. As an additional example, based on the shape and size of the individual plates, the plates may be arranged in a manner resembling chainmail, a chainmail pattern, a fish scale pattern, and the like.

In FIG. 3d, individual plates may be affixed to the elastic sheet 334 using any known method of joining two separate items together. For example, the individual plates may be affixed to elastic sheet 334 by glue, thread, staples, tape, and the like.

The discussed examples of flexible members and examples of joining together individual plates are not limiting and were provided as examples of how a layer of plates may be assembled and arranged. Thus, FIGS. 3a, 3b, 3c, and 3d provide additional details of the layers of plates that may be embedded within the upper of a boot or shoe such as boot 100 (as discussed in FIGS. 1, 2a, 2b, and 2c). One or more layer of plates are constructed such that the layer may bend and flex with the upper of a boot or shoe while also providing protection when a heavy or sharp object falls on a person's foot. One or more layer of plates may be embedded in portions of the upper that coincide with regions of the foot including the metatarsus as well as regions of the lower leg including the fibula and tibia (when a boot is worn).

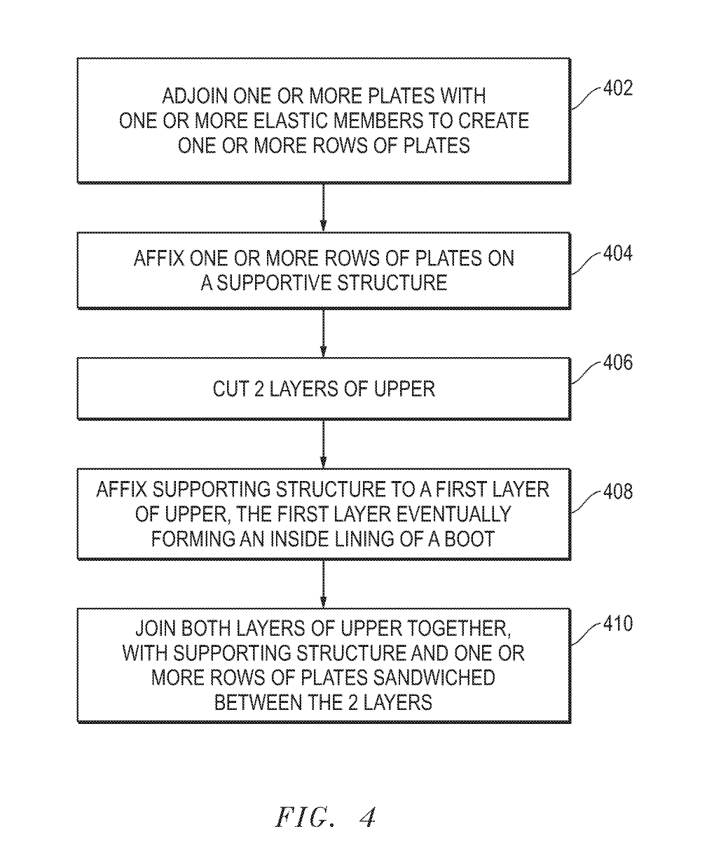

FIG. 4 shows a method for constructing a layer of plates and embedding the layer within a shoe in accordance with example embodiments. In various embodiments, some of the blocks shown in FIG. 4 may be performed concurrently, in a different order than shown, or omitted. Additional method elements may be performed as desired.

At block 402, one or more plates are adjoined with one or more flexible members to create one or more row of plates. The flexible members may comprise an elastic string, rubber bands, an elastic sheet, flexible polymers, and the like. In the example, where an elastic string is used, the individual plates may be glued to the elastic string, spaced apart from each other by a predetermined distance.

At block 404, the one or more rows of plates are affixed to a supporting structure. Continuing the previous example, the single row of plates glued to an elastic string may initially be placed on the supporting structure. Both ends of the elastic string may be glued to the supporting structure, leaving the remaining portion of the elastic string (comprising the affixed plates) to move, stretch, and bend.

Another row of plates may be placed adjacent to the first row of plates, where the ends of the second row of plates of glued to the supporting structure, so on and so forth. Until a grid of plates is formed on the supporting structure. The supporting structure may comprise foam or other material that may absorb a blow and that may mold to the shape of a portion of the upper of a boot or shoe.

At block 406, two layers of material may be cut, or bifurcated, where the two layers of material are cut, and molded to form the upper of a boot or shoe. At block 408, the supporting structure may be affixed to a first layer of the two layers of material. For example, the supporting structure may be glued to the first layer. Additionally, the first layer may eventually form an inside lining of the upper of a boot or shoe.

At block 410, both layers may be joined together (e.g., stitched, glued, and the like) together such that the one or more rows of plates and the supporting structure are sandwiched between the two layers. The two layers may then be molded to form an upper of a boot or shoe. The supporting structure and one or more rows of plates may be positioned throughout various parts of the upper of the shoe or boot. For example, the layer of plates and supporting structure may by embedded within the upper such that when the boot is worn, the layer of plates and supporting structure cover or are adjacent to regions of the foot including the metatarsus and regions of the lower leg including the fibula and tibia.

Thus, a boot may be made that comprises one or more layer of plates that may be embedded throughout and in various parts of the upper. The layer of plates are not visible from either the outside of the boot or from the inside (where the foot is placed) and further the layer of plates conform to the shape of the upper. The layer of plates are constructed such that the layer may bend and flex with the upper of the boot while also providing protection when a heavy or sharp object falls on a person's foot. The layer of plates may include a support structure that may also provide additional cushioning to absorb impact.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

Further, it should be understood that the embodiments of FIGS. 1-4 illustrate example embodiments and that features of each may be used together. As such, each figure is not intended to represent distinct or unique embodiments separate from each other. For example, the one or more flexible members 218 of FIG. 2 may be used to form elastic strings of plates in the boot 100 in FIG. 1.

While preferred embodiments of this disclosure have been shown and described, modifications thereof can be made by one skilled in the art without departing from the scope or teaching herein. The embodiments described herein are exemplary only and are not limiting. Because many varying and different embodiments may be made within the scope of the present inventive concept, including equivalent structures, materials, or methods hereafter thought of, and because many modifications may be made in the embodiments herein detailed in accordance with the descriptive requirements of the law, it is to be understood that the details herein are to be interpreted as illustrative and not in a limiting sense

What is claimed is:

1. A boot comprising:
an outsole; and
an upper attached to the outsole, the upper having a vamp portion comprising:
a first layer;
a second layer disposed underneath the first layer; and
a layer of plates disposed between the first layer and the second layer, the layer of plates arranged in one or more rows across the vamp portion,
wherein a shape of the layer of plates conforms to a shape of the upper, and
wherein a first individual row of the one or more rows stretch with respect to a second individual row of the one or more rows.

2. The boot of claim 1, further comprising:
a supporting layer disposed under the layer of plates, the supporting layer affixed to the second layer.

3. The boot of claim 1, wherein the second layer forms an inner liner of the boot.

4. The boot of claim 1, wherein each of the one or more rows are held together by a corresponding flexible member.

5. The boot of claim 1, wherein each of the one or more rows of plates are spaced less than 1/16 of an inch apart from other rows of the one or more rows.

6. The boot of claim 1, wherein a location of the layer of plates corresponds to a region of a foot within the boot including the metatarsus.

7. The boot of claim 1, wherein a location of the layer of plates corresponds to a region of a leg within the boot including a portion of the tibia.

8. A layer of plates, embedded within an upper of a boot, comprising:
a supporting layer;
a first row of one or more plates, the one or more plates of the first row adjoined together by an elastic member;
a second row of one or more plates, the one or more plates of the second row adjoined together by an additional elastic member,
wherein opposite ends of the first row are affixed to the supporting layer, and
wherein opposite ends of the second row are affixed to the supporting layer.

9. The layer of plates of claim 8, wherein the layer of plates is embedded within a region of the boot that corresponds to a region of a foot within the boot including the metatarsus.

10. The layer of plates of claim 8, wherein:
a first portion of the layer of plates is embedded within a vamp of the boot; and
a second portion of the layer of plates is embedded with a shaft of the boot.

11. The layer of plates of claim 8, wherein the layer of the plates is embedded within a portion of a vamp of a boot.

12. The layer of plates of claim 8, wherein:
the layer of plates is embedded within a shaft of the boot, and
wherein the layer of plates is embedded within a region of the boot that corresponds to a region of a lower leg within the boot including the tibia.

13. The layer of plates of claim 8, wherein the elastic member is one of an elastic string, elastic loops, or an elastic sheet.

14. The layer of plates of claim 8, wherein the one or more plates of the first row, and the one or more plates of the second row are arranged in at least one of a: columns, rows, a grid-like pattern, a fish scale pattern, and a chainmail pattern.

15. The layer of plates of claim 8, wherein:
the layer of plates is embedded with an upper of a boot,
the layer of plates conform to a shape of the upper, and
the layer of plates is flexible.

16. The layer of plates of claim 8, wherein:
the layer of plates is disposed between a first layer and a second layer forming the upper of the boot,
the layer of plates is not visible at the exterior of the boot, and
the layer of plates is not visible in the interior of the boot.

17. A method of fabricating a boot comprising:
adjoining one or more plates with one or more elastic members to create one or more rows;
affixing the one or more rows to a supporting structure to create a layer of plates;
bifurcating a material to create a first layer and a second layer;
affixing the supporting structure to the first layer;
affixing the first layer to the second layer such that the layer of plates is disposed between the first layer and the second layer; and
shaping the first layer and the second layer of material to form an upper of the boot.

18. The method of claim 17, wherein the one or more plates comprises at least one of: steel, aluminum, and composite materials.

19. The method of claim 17, wherein affixing the one or more rows to a supporting structure further comprises:
affixing both ends of an individual row of the one or more rows to the supporting structure.

20. The method of claim 17, wherein the layer of plates is disposed between the first layer and the second layer such that the layer of plates corresponds to a region of a foot within the boot including the metatarsus.
